(19) United States
(12) Patent Application Publication
(10) Pub. No.: US 2013/0249816 A1
(43) Pub. Date: Sep. 26, 2013

(54) TOUCH CONTROL DEVICE AND TOUCH CONTROL METHOD USING SAME PROVIDING ENVIRONMENT COMPENSATION SIGNAL

(71) Applicants: ZHANG-YONG ZHENG, Shenzhen City (CN); BI-QING LUO, Shenzhen City (CN); REN-WEN HUANG, Shenzhen City (CN); HUA-LIN LIU, Shenzhen City (CN); BIAO-GENG ZHONG, Shenzhen City (CN); XIN LU, Shenzhen City (CN)

(72) Inventors: ZHANG-YONG ZHENG, Shenzhen City (CN); BI-QING LUO, Shenzhen City (CN); REN-WEN HUANG, Shenzhen City (CN); HUA-LIN LIU, Shenzhen City (CN); BIAO-GENG ZHONG, Shenzhen City (CN); XIN LU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/479,275

(22) Filed: May 24, 2012

(30) Foreign Application Priority Data
Mar. 20, 2012 (CN) 201210074168.8

(51) Int. Cl. G06F 3/041

(52) U.S. Cl. 345/173

(57) ABSTRACT

A touch input device includes a primary touch panel, a primary touch driver, an environment compensation unit, a processor, and an operation module. The primary touch panel generates a first change of electric charge distribution according to a touch on the primary touch panel from a user. The primary touch driver generates a touch signal according to the first change of electric charge distribution to the primary touch panel. The environment compensation unit detects a second change of electric charge distribution of an environment and generates a compensating signal. The processor processes the touch signal and the compensating signal to produce a reliable touch signal. The operation module performs a function according to the reliable touch signal.

### BACKGROUND

1. Technical Field

The present disclosure relates touch control devices, and particularly to a touch control device which includes a primary touch panel for generating touch signals and a secondary touch panel for automatically providing an environment compensation signal.

2. Description of Related Art

Touch input devices, such as capacitive touch panels have been used widely in place of other input devices such as keypads. A capacitive touch panel may be attached to a display screen of a machine, such as a computer or smart phone for example, and configured for inputting signals. When a user presses the capacitive touch panel with his or her finger or a touch pen, electric charge distribution at the point of touch changes, and this change causes signal input and results in a corresponding response from the machine distribution of electric charge thereof.

However, this kind of touch panel can be overly sensitive to the environment and respond to changes in temperature humidity that result in false readings of touches.

Therefore, a new touch input device is needed.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic block diagram of a touch input device provided by one embodiment of the present disclosure.

FIG. 2 is a timing diagram of the touch input device of FIG. 1.

FIG. 3 is a flowchart of an exemplary touch control method using the touch input device of the first embodiment.

FIG. 4 is an isometric view of a touch input device according to one embodiment of the present disclosure.

### DETAILED DESCRIPTION

Reference will now be made to the drawings to describe various embodiments in detail.

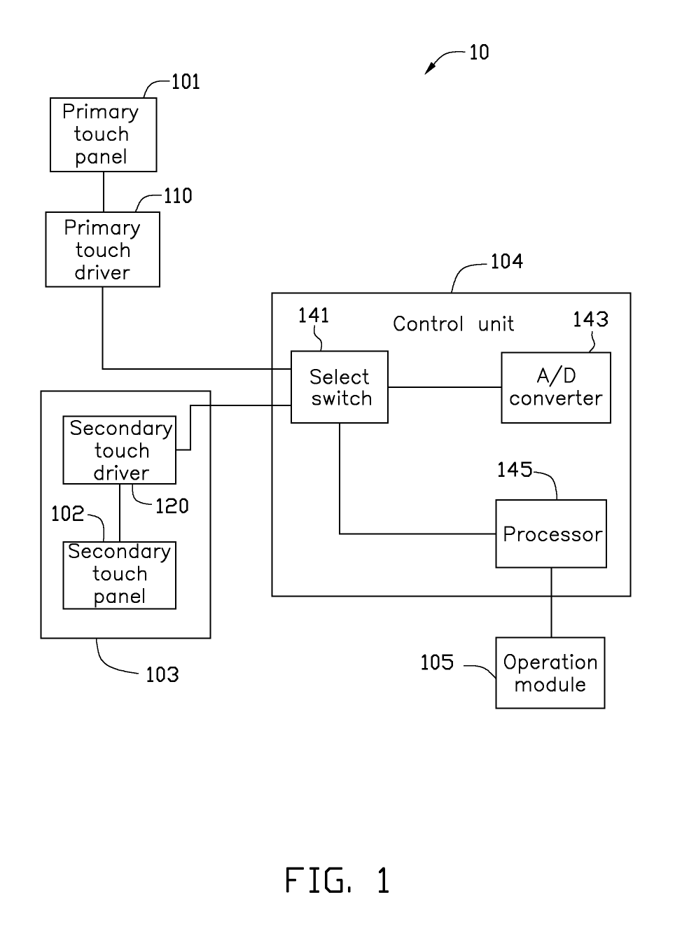

Referring to FIG. 1, a schematic block diagram of a touch input device 10 of one embodiment of the present disclosure is shown. The touch input device 10 includes a primary touch panel 101, a primary touch driver 110, an environmental compensation unit 103, a control unit 104, and an operation module 105. In general, the word “module”, as used herein, refers to logic embodied in hardware or firmware, or to a collection of software instructions, written in a programming language, such as, Java, C, or Assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The primary touch panel 101 is configured to receive a touch action such as a single touch from an object such as a stylus or fingertip for example. When a user touches the primary touch panel 101 with a fingertip or a stylus, electric charge distribution at the point of touch will change. In this embodiment, the primary touch panel 101 may be a resistance type touch panel or capacitance type touch panel.

The primary touch driver 110 is configured to detect a first change of electric charge distribution of the primary touch panel 101 and generate a corresponding touch signal “A.”

The environment compensation unit 103 is configured to sense second change of electric charge distribution caused by environment around the primary touch panel 101, and generate a compensating signal “B” accordingly. The compensating signal “B” compensates for environmentally generated change of electric charge distribution thus preventing false touch readings.

In one embodiment, the compensation unit 103 includes a secondary touch panel 102 and a secondary touch driver 120. In this embodiment, the secondary touch panel 102 is configured to respond to changes of electric charge distribution of secondary touch panel 102 in the same way as the primary touch panel 101 and can be made of the same materials as the primary touch panel 101. The secondary touch panel 102 is configured in a way that prevents a user touching it so that any changes in of electric charge distribution (hereafter called “a second change of electric charge distribution”) may be considered to be solely caused by the environment around the touch input device 10. In one embodiment, a cover overlapping the secondary touch panel 102 may be set to prevent the user from touching the secondary touch panel 102.

The secondary touch driver 120 is configured to detect the second change of electric charge distribution, and generate the compensating signal “B” accordingly.

The control unit 104 includes a select switch 141, an analog/digital (A/D) converter 143, and a processor 145.

The select switch 141 includes two inputs correspondingly connected to the primary touch driver 110 and the secondary touch driver 120, an output connected to the A/D converter 143, and a control terminal connected to the processor 145. The select switch 141 is configured to selectively transmit the touch signal “A” or the compensating signal “B” to the processor 145 via the A/D converter 143. In one embodiment, the select switch 141 may be a time division multiplexing switch.

The A/D converter 143 receives the touch signal “A” and the compensating signal “B” from the primary touch driver 110 and the secondary touch driver 120 respectively, transforms the touch signal “A” and the compensating signal “B” from analog signals into digital signals, and sends them to the processor 145.

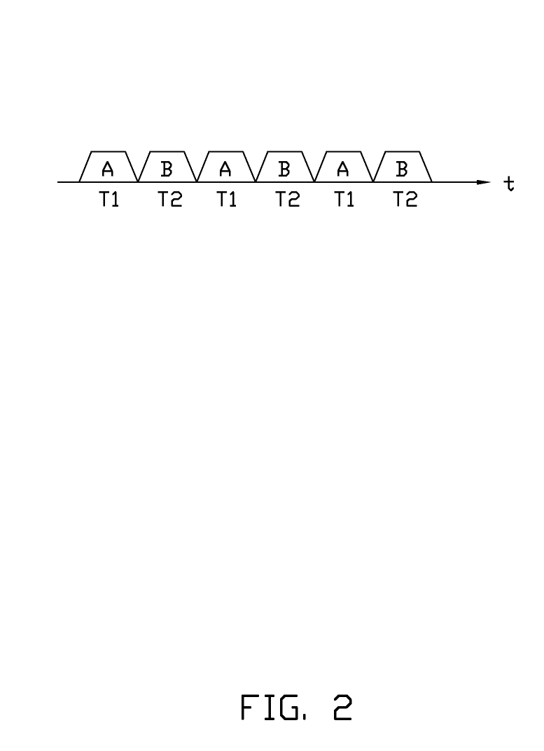

In one embodiment, the touch signal “A” and the compensating signal “B” are sequentially sent to the processor 145 in a time division mode as shown in FIG. 2. In detail, in a first time period “T1”, the select switch 141 transmits the touch signal “A” to the processor 145 via the A/D converter 143. In a second time period “T2”, which follows the first time period “T1”, the select switch 141 transmits the compensating signal “B” to the processor 145 via the A/D converter 143.

The processor 145 processes the touch signal “A” and the compensating signal “B” to generate a control signal “C” which is essentially touch signal “A” minus any environmentally induced change of electric charge distribution. In one embodiment, the processor 145 subtracts the compensating signal “B” from the touch signal “A” to generate the control signal “C”. The processor 145 then compares the control signal “C” with a predetermined reference value. If the control signal “C” is greater than the predetermined reference value, the processor 145 provides the control signal “C” to the operation module 105. If the control signal “C” is less than the predetermined reference value, the control signal “C” will not be provided to the operation module 105.

The operation module 105 is configured to receive the control signal “C” and perform a corresponding function related to a touch position of the primary touch panel 101.

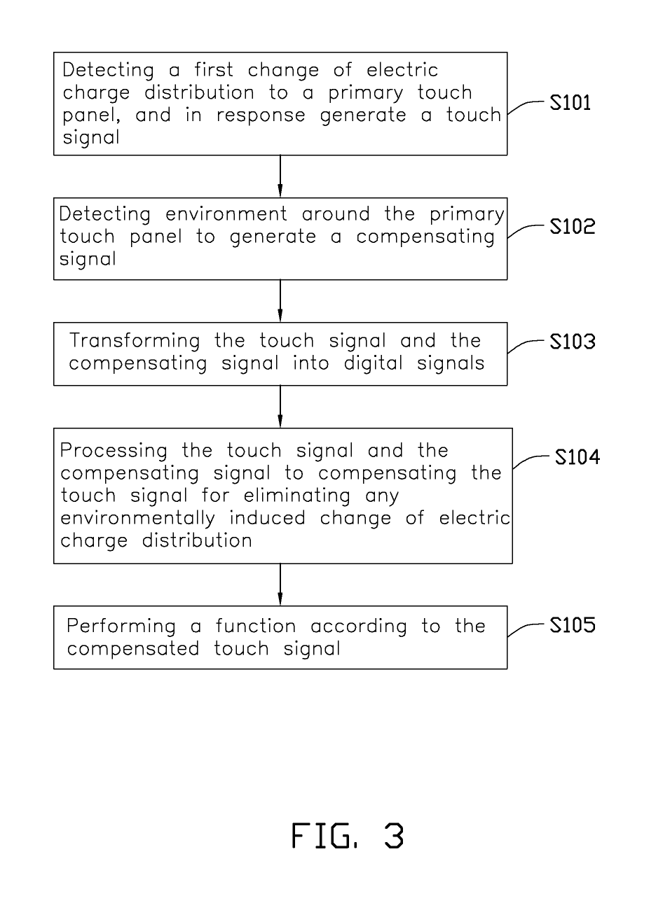

Referring to FIG. 3, a flowchart of an exemplary touch control method using the touch input device 10 of the first embodiment is shown. The touch control method includes the following steps. Depending on the embodiment, additional steps may be added, others removed, and the ordering of the steps may be changed.

In step S101, the primary touch panel 101 is touched by a user to generate a first change of electric charge distribution. The primary touch driver 110 is configured to detect the first change of electric charge distribution and in response generate a touch signal “A”.

In step S102, the environment around the primary touch panel 101 which may influence the change of electric charge distribution of the primary touch panel 101 is sensed. In detail, the secondary touch panel 102 is configured to generate a second change of electric charge distribution without the touch of the user and the secondary touch driver 120 is configured to sense the second change of electric charge distribution to generate a compensating signal “B”.

In step S103, the touch signal “A” and the compensating signal “B” are selectively transmitted to the A/D converter 143 and transformed into digital signals. The touch signal “A” and the compensating signal “B” are then transmitted to the processor 145.

In step S104, the processor 145 processes the touch signal “A” and the compensating signal “B” to generate a control signal “C” which minus any environmentally induced change of electric charge distribution.

In step S105, a corresponding function is performed by the operation module 105 according to the control signal “C” if the control signal “C” is greater than a predetermined reference value.

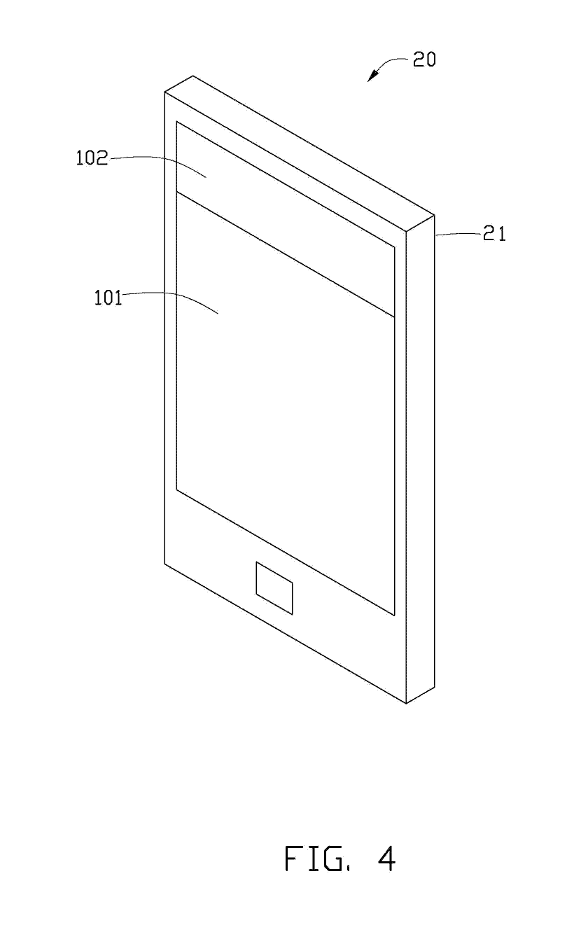

Referring to FIG. 4, an isometric view of a touch input device 20 according to one embodiment of the present disclosure is shown. In one embodiment, the touch input device 20, for example, is a mobile phone. The touch input device 20 includes a housing 21. The primary touch panel 101 and the secondary touch panel 102 are disposed on a surface of the housing 21 and arranged adjacent to each other. In one embodiment, an area of the primary touch panel 101 is much larger than that of the secondary touch panel 102.

It is to be understood that even though numerous characteristics and advantages of the present embodiments have been set forth in the foregoing description, with details of the structures and functions of the embodiments, the disclosure is illustrative only; and that changes may be in detail, especially in matters of shape, size, and arrangement of parts, within the principles of the embodiments, to the full extent indicated by the broad general meaning of the terms in which the appended claims are expressed.

What is claimed is:

1. A touch input device, comprising:
a primary touch panel configured for generating a first change of electric charge distribution according to a touch on the primary touch panel from a user;
a primary touch driver configured for generating a touch signal according to the first change of electric charge distribution of the primary touch panel;
an environment detect unit configured for detecting a second change of electric charge distribution of an environment around the primary touch panel, and in response, generating a compensating signal;
a processor configured for compensating the touch signal according to the touch signal and the compensating signal; and
an operation module configured for performing a function related to the compensated touch signal.

2. The touch input device of claim 1, wherein the environment detect unit comprises a secondary touch panel and a secondary touch driver, the secondary touch panel is configured for generating the second change of electric charge distribution without being touched, the secondary touch driver is configured for detecting the second change of electric charge distribution to generate the compensating signal.

3. The touch input device of claim 1, further comprising an analog/digital (A/D) converter configured for transforming the touch signal and the compensating signal from analog signal into digital signal.

4. The touch input device of claim 1, wherein the compensated touch signal is a touch signal minus any environmentally induced change of electric charge distribution to the primary touch panel.

5. The touch input device of claim 4, wherein the processor subtracts the compensating signal from the touch signal to obtain the compensated touch signal.

6. The touch input device of claim 5, wherein the processor compares the touch signal with a predetermined reference value, and sends the compensated touch signal to the operation module according to comparison result.

7. The touch input device of claim 6, wherein the processor provides the compensated touch signal to the operation module if the compensated touch signal is greater than the predetermined reference value.

8. The touch input device of claim 2, further comprising a select switch connected to the primary touch driver and the secondary touch driver.

9. The touch input device of claim 8, wherein the select switch is configured to selectively transmit the touch signal or the compensating signal to the processor.

10. The touch input device of claim 8, wherein the select switch is a time division multiplexing switch.

11. A touch input method, comprising:
generating a first change of electric charge distribution to a primary touch panel according to a touch on the primary touch panel from a user;
generating a touch signal by a primary touch driver according to the first change of electric charge distribution;
detecting a second change of electric charge distribution of an environment around the primary touch panel, and in response, generating a compensating signal by an environment detect unit;
processing the touch signal and the compensating signal to compensate the touch signal by a processor; and
performing a function according to the compensated touch signal by an operation module.

12. The touch input method of claim 11, wherein the environment detect unit comprises a secondary touch panel and a secondary touch driver, the secondary touch panel is configured for generating the second change of electric charge distribution without being touched, the secondary touch driver is configured for detecting the second change of electric charge distribution to generate the compensating signal.

13. The touch input method of claim 11, further comprising transforming the touch signal and the compensating signal from analog signal into digital signal by an analog/digital (A/D) converter.

14. The touch input method of claim 11, wherein the compensated touch signal is a touch signal minus any environmentally induced change of electric charge distribution to the primary touch panel.

15. The touch input method of claim 14, wherein the compensated touch signal is obtained by subtracting the compensating signal from the touch signal.

16. The touch input method of claim 15, wherein the processor compares the compensated touch signal with a predetermined reference value and provides the touch signal to the operation module if the compensated touch signal is greater than the predetermined reference value.

17. The touch input method of claim 11, further comprising selectively transmitting the touch signal or the compensating signal to the processor by a select switch.

18. The touch input method of claim 17, wherein the select switch is a time division multiplexing switch.
